(19) United States
(12) Patent Application Publication
(10) Pub. No.: US 2021/0325906 A1
(43) Pub. Date: Oct. 21, 2021

(54) METHOD AND APPARATUS FOR DETERMINING NAVIGATION ROUTES BASED ON ENVIRONMENTAL QUALITY DATA

(71) Applicant: HERE Global B.V., Eindhoven (NL)

(72) Inventor: Donta WHITE, Racine, WI (US)

(21) Appl. No.: 16/851,929

(22) Filed: Apr. 17, 2020

(51) Int. Cl. G05D 1/10; G05D 1/08; B64C 39/02

(52) U.S. Cl. CPC G05D 1/106; B64C 2201/141; B64C 39/024; G05D 1/0808

(57) ABSTRACT

An approach is provided for mapping geo-referenced environmental factors and generating navigation routes. The approach, for example, involves receiving environmental quality data and determining from that data geo-referenced environmental factors over a geographic and/or three-dimensional region. The determined geo-referenced environmental factors can be based on real-time data, historical data, or a combination thereof. The approach also involves generating a map data layer of a geographic database based on the geo-referenced environmental factors.

### BACKGROUND

As drone delivery becomes an increasingly common way to deliver cargo, ensuring that cargo arrives at its destination unaffected by environmental hazards will become a major issue within the fulfillment processes. For example, the use of unmanned aerial drones for delivering food requires extra attention to avoid contaminating the food with environmental hazards such as airborne pesticides and smog. As a result, drone operators and related service providers face significant technical challenges to minimize the risk of contaminating their cargo from such hazards.

### SOME EXAMPLE EMBODIMENTS

Therefore, there is a need for an approach for generating navigation routes based on environmental quality data in order to ensure that an aerial vehicle's cargo can be consumed or used in a manner for which it was intended.

According to one embodiment, a method comprises determining a cargo to be carried on a navigation route, receiving the environmental quality data for a geographic and/or three-dimensional region associated with at least one candidate route, wherein the environmental quality data indicates whether there is at least one geo-referenced environmental factor that affects the cargo, generating the navigation route based on the environmental quality data of the at least one candidate. In one embodiment, the navigation route is generated for an aerial drone, wherein the navigation route specifies an altitude to route the aerial vehicle based on the at least one geo-referenced environmental factor. In another embodiment, the at least one geo-referenced environmental factor positively affects the cargo so that the cargo is preserved to be consumed or used in a manner for which the cargo was made or designed.

According to another embodiment, an apparatus comprises at least one processor, and at least one memory including computer program code for at least one program, the at least one memory and the computer program code configured to, with the at least one processor, cause, at least in part, the apparatus to receive data indicating at least one geo-referenced environmental factor that is classified as affecting a cargo that is carried on the navigation route, and generate map data representing the at least one geo-referenced environmental factor in a geographic database; and provide the map data for generating the navigation route. In one embodiment, the map data is stored in an environmental quality data layer of the geographic database. The apparatus is also caused to provide the map data for generating the navigation route.

According to another embodiment, a non-transitory computer-readable storage medium carries one or more sequences of one or more instructions which, when executed by one or more processors, cause, at least in part, an apparatus to determine a cargo to be carried on a navigation route, receive environmental quality data for a geographic and/or three-dimensional region associated with at least one candidate route, determining that the environmental quality data indicates that there is at least one geo-referenced environmental factor that is classified as affecting the cargo, generating a map data layer based on the environmental quality data including, the at least one geo-referenced environmental factor. In one embodiment, the apparatus is further caused to retrieve real-time data, historical data, or a combination thereof indicating the environmental quality data, wherein the environmental quality data is based on the real-time data, the historical data, or a combination thereof. In another embodiment, the apparatus creates a data model representing the at least one geo-referenced environmental factor, wherein the map data layer further includes the data model.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: an apparatus comprising means for performing a method of any of the claims.

Still other aspects, features, and advantages of the invention are readily apparent from the following detailed description, simply by illustrating several particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of mapping geo-referenced environmental factors and generating navigation routes, according to one embodiment;

FIG. 2 is a diagram of the components of a cargo routing platform, according to one embodiment;

FIG. 3 is a flowchart of a process for mapping geo-referenced environmental factors, according to one embodiment;

FIG. 4A is a diagram of a user interface illustrating geo-referenced environmental factors, according to one embodiment;

FIG. 4B is a diagram of a user-interface illustrating a geo-referenced environmental factor risk data model, according to one embodiment;

FIG. 4C is a perspective diagram of a user-interface illustrating a geo-referenced environmental factor risk data model, according to one embodiment;

FIG. 5 is a diagram of a geographic database capable of storing map data for drone routing, according to one embodiment;

FIG. 6 is a diagram of hardware that can be used to implement an embodiment;

FIG. 7 is a diagram of a chip set that can be used to implement an embodiment; and

FIG. 8 is a diagram of a mobile terminal (e.g., handset or vehicle or part thereof) that can be used to implement an embodiment.

### DESCRIPTION OF SOME EMBODIMENTS

Examples of a method, apparatus, and computer program for generating a navigation route based on environmental quality data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

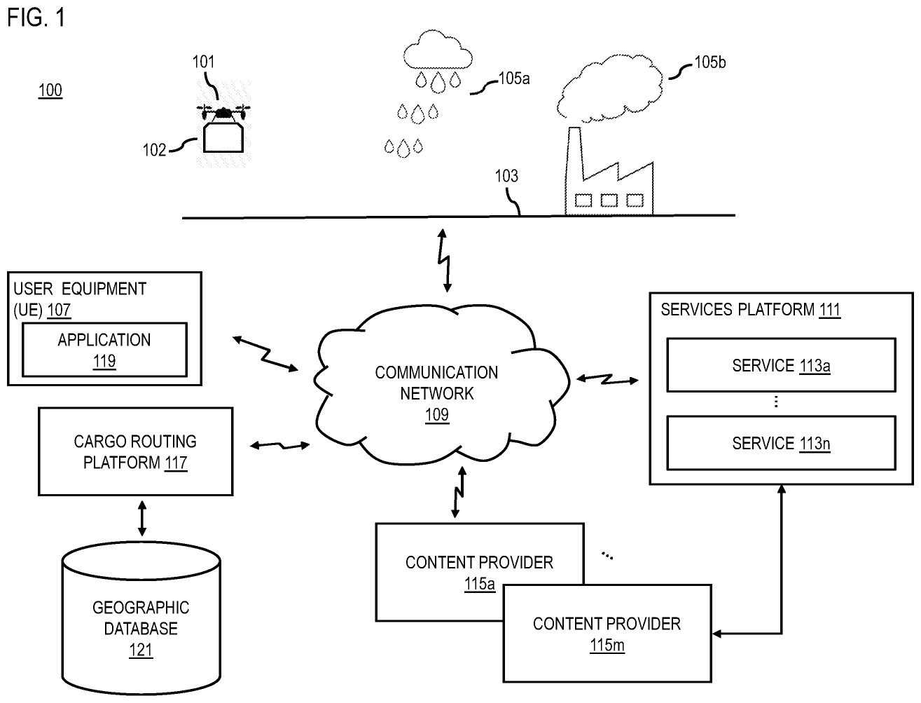

FIG. 1 is a diagram of a system 100 capable of generating navigation route data based on environmental quality data, according to one embodiment. As noted above, the use of aerial vehicles (e.g., aerial drones, unmanned aerial vehicles (UAVs) and/or any other type of remotely operated vehicle) is becoming more widespread particularly for commercial services such as package delivery. Commercial delivery services generally require high target of levels of successful trips (e.g., successfully reaching a delivery location or other destination with cargo preserved for its intended use). However, as drone delivery services become more common, these services may also face growing risks from environmental factors (e.g., heat, cold, wind, rain, pesticides, air pollution, electromagnetic radiation, radioactive radiation, infectious disease, birds, insects, air pollution, fire, acid rain) encountered along their routes. Therefore, service providers face significant technical challenges to optimize drone navigational routing to ensure successful trip completion in light of threats to the cargo 102 posed by environmental factors.

For the embodiments described herein, the term cargo refers to all types of items and/or packaging suitable for delivery and may be known by other terms including but not limited to cargo, freight, payload, goods, package, parcel, box, bag, shrink-wrap, blister pack or some combination thereof. As used herein, the term environmental factor refers to any manmade or natural factor that is capable of affecting the cargo 102 of an aerial vehicle 101.

Although the various embodiments described herein are discussed with respect to aerial vehicles 101 operating in the airspace above the ground, it is contemplated that the embodiments are applicable to any type of vehicle (manned or unmanned, autonomous or manually-controlled) including those operating on the surface of the Earth. For example, in an alternative embodiment, vehicles other than aerial vehicles 101, including but not limited to surface or ground vehicles (e.g., delivery robots, cars, trucks, trains, ships, etc.), can be used according to the various embodiments described herein.

Generally, an aerial vehicle 101 may operate relative to (e.g., above, under, through, in, around, etc.) the ground 103, and/or any other environmental factors that may affect the cargo 102 of the aerial vehicle 101 (e.g., rain 105a, smoke from a power plant 105b, etc.—also collectively referred to as environment 105. In one embodiment, the environmental factors have been geo-referenced to become geo-referenced environmental factors, wherein the environmental factors have been related to a ground system of geographic coordinates and/or corresponding volume of airspace. For example, the smoke from the power plant 105b can be identified based on the geo-coordinates (e.g., latitude and longitude) along with corresponding altitudes describing the boundaries of an airspace volume or plume associated with the geo-referenced environmental factors. It is noted that the system of denoting a geo-referenced environment factor using latitude, longitude, and altitude of boundary points are provided by way of illustration and not as a limitation. It is contemplated that the system 100 can use any other equivalent means of designating the extent of airspace volume or geographic area that is associated with or otherwise affected by/exhibiting the environmental factor.

By way of example, an aerial vehicle 101 is tasked to deliver cargo 102, which comprises a cardboard box containing an electronic device. If the cargo 102 passed through the rain 105a, 1) the cardboard would absorb water, expose the electronic device to that water, and damage the device, and/or 2) the cardboard would absorb water, lose its strength, and allow the electronic device to fall through the box, impact the ground, and damage the device. In another example, an aerial vehicle 101 is tasked to deliver fresh fruit as its cargo 102. If the strawberries traveled through the smoke from the power plant 105b, the strawberries may become contaminated with soot and toxic chemicals, rendering them unfit for consumption. In a further example, the strawberries may travel through regions with high amounts of agricultural activity, where the density of airborne pesticides, or pesticide drift, reaches harmful levels and contaminate the strawberries to an extent that makes them unfit for consumption. Another environmental factor that may affect cargo 102 includes flying insects that carry infectious diseases such as mosquitos carrying West Nile virus. In an example where the cargo 102 is an organ destined for organ transplantation, air temperature is an environmental factor that may affect the cargo—if the cargo 102 is carried by the aerial vehicle 101 at an altitude where the air temperature is too warm for organ preservation, the organ may not survive.

To address the technical challenges, the system 100 of FIG. 1 introduces a capability to map geo-referenced environmental factors occurring over a geographic and/or three-dimensional region, and then use the mapped data do generate a navigation route over the geographic and/or three-dimensional region that is optimized based on the geo-referenced environmental factors (e.g., by using a routing cost function that avoids regions with densities of a geo-referenced environmental factor above a threshold density). In one embodiment, the system 100 can also configure an aerial vehicle 101 to react in real-time and/or to re-route based on the mapped historical and real-time data and intelligence on environmental factors. In this way, the system 100 can combine optimized drone routes with real-time edge decision making at critical decision points to ensure the success of a cargo delivery mission.

In one embodiment, to map the geo-referenced environmental factors, the system 100 can incorporate environmental quality data, such as but not limited to the historical and real-time probe data (e.g., from other drones), sensor data, and/or other available data on environmental factors in a given geographic and/or three-dimensional region. For example, one type of geo-referenced environmental factor is radioactive radiation (e.g., ionizing radiation). In this example, the system 100 can query data indicating radioactivity in each geographic and/or three-dimensional region encompassing a nuclear disaster region. In one embodiment, the system 100 can combine the queried data with other environmental quality data that affects the spread of radioactivity such as but not limited to wind vector data, rainfall data, tidal current data, or some combination thereof to generate map data indicating the historical and/or real-time locations and intensities of radioactive radiation in the given geographic and/or three-dimensional region. The map data can represent the geo-referenced environmental factor and/or be stored in an environmental quality data layer of the geographic database 121. The map data in the geographic database 121 can then be used to predict the exposure level of a cargo 102 to radioactive radiation or to generate navigation routes that avoid or minimize potential exposure to the radioactive radiation. In this way, the system 100 advantageously enables drone operators to navigate their cargo 102 with reduced risks or with a greater understanding of the risks arising from encountering radioactive radiation on a route.

In another embodiment, the system 100 generates map data representing a geo-referenced environmental factor, wherein the map data further represents an altitude extent of the geo-referenced environmental factor, and wherein the navigation route specifies an altitude to route an aerial drone based on the altitude extent, the at least one geo-referenced environmental factor, or a combination thereof. By way of example, the system 100 generates map data representing a plume of smoke 105b emitted from a power plant. The map data indicates that the plume has an altitude extent of 30 meters with the base of the plume at an elevation of 70 meters. Based on the map data, the system 100 generates a navigation rout specifying the aerial vehicle 101 to fly at an altitude of 100 meters or higher, altitude extent of 30 meters plus elevation of the plume's base of 70 meters, in order to avoid the plume. In an embodiment, the system 100 determines the cargo 102's height and width and adds it to the aerial vehicle's dimensions before generating a navigation route. For example, a cargo 102 has a height of 15 centimeters (cm), a width of 15 cm and depth of 15 cm. and is carried attached flush to the aerial vehicle's bottom-most member. In an embodiment for this example, the system 100 determines the dimensions of the cargo 102 and aerial vehicle 101 together as a unit then generates a navigation route based on the determined dimensions. The height of the cargo 102 and aerial vehicle 101 together is now their two heights summed together. The width of the of the cargo 102 and aerial vehicle 101 together is the larger of the two dimensions. Similarly, the depth of the of the cargo 102 and aerial vehicle 101 together is the larger of the two dimensions. The generated navigation route based on the determined dimensions more accurately avoids encounters between the cargo 102 and geo-referenced environmental factors.

In another embodiment, to map the geo-referenced environmental factors, the system 100 can select from environmental quality data a geo-referenced environmental quality factor based on a cargo type of the cargo.

In summary, the data used by the system 100 to map geo-referenced environmental factors and/or route/re-route/react/etc. to or away from geo-referenced environmental factors include but are not limited to available real-time and historical data for environmental factors (e.g., heat, cold, wind, rain, pesticides, air pollution, electromagnetic radiation, radioactive radiation, infectious disease, birds, insects, air pollution, fire, acid rain).

In one embodiment, the system 100 enables human and machine pilots or other operators of drones 101 to calculate the risks to cargo 102 associated with a given geographic or three-dimensional region by determining geo-referenced environmental factors based on environmental quality data. To calculate these risk factors, the system 100 can model different types of geo-referenced environmental factors in each geographic and/or three-dimensional region. This data model can indicate the densities and/or intensities of each geo-referenced environmental factor. The density and/or intensity, for example, indicates to what extent cargo 102 may be affected for a given time of exposure to the geo-referenced environmental factor. The data model can then be combined with terrain data to assist in generating a navigation route for the aerial vehicle 101. In the embodiments described herein, intensity may include any measure that describes a characteristic of an environmental factor such as but not limited to power, amplitude, magnitude, strength, level, or toxicity.

For instance, in an example scenario, environmental quality data for a given geographic and/or three-dimensional region indicates that there is a geo-referenced environmental factor—a high-density and high-toxicity plume of airborne pesticides that reaches a maximum elevation of 50 meters (e.g., based on real-time environmental quality data obtained through the sensor of other drones and/or historical research data). The system 100 classifies a geo-referenced environmental factor as affecting a cargo based on determining that the geo-referenced environmental factor negatively affect the cargo so that the cargo cannot be consumed or used in the manner for which the cargo was made or designed. In this example, the system 100 has modeled that a cargo 102 of baby food, if exposed to the airborne pesticides in that given region for more than 2 minutes, would be negatively affected to an extent that makes the baby food unfit for consumption and classifies the geo-referenced environmental factor as affecting the cargo. The system 100 further models that there is a 60-meter-tall hill west of the region. Thus, the system 100 may determine that an aerial vehicle flying west to avoid the region of airborne pesticides may still affect the cargo by impacting the hill if flying at altitudes of 60 meters or lower. Utilizing this data model, the system 100 can then generate a navigation route so that the cargo 102 of baby food is not so affected as to become damaged or unfit for consumption.

In another embodiment, the system 100 identifies in environmental quality data at least one geo-referenced environmental factor that positively affects the cargo so that the cargo is preserved to be consumed or used in a manner for which the cargo was made or designed. The system 100 then generates a navigation route to go through the at least one geo-referenced environmental factor.

In an embodiment, the system 100 identifies in environmental quality data at least one geo-referenced environmental factor that negatively affects cargo and the system 100 determines whether any cargo is being carried by the aerial vehicle 101. If the system 100 determines that no cargo is being carried, the system 100 generates a navigation route to go through the at least one geo-referenced environmental factor.

In one embodiment, the system 100 can then represent or visualize the calculated risks as a “risk data layer” of the geographic database 121 for the geographic and/or three-dimensional region where the cargo 102 will travel through. In one embodiment, the visual representation or “risk data layer” highlights or otherwise indicates the risk to the cargo 102 of travelling through a region represented by the risk data layer based on data such as but not limited to the density and/or intensity of geo-referenced environmental factors. In other embodiments, the risk data layer is a combination of risks composed of one or more other risk factors (e.g., visible or invisible) associated with the safety of the cargo, drone, people and/or environment in the event of a crash. Those risk factors include but are not limited to geographic features, terrain, buildings, bodies of water, nature preserves, etc. in combination with the risks from the geo-referenced environmental factors.

On example representation of the “risk data layer” is an indication of density of at least one geo-referenced environmental factor over a region of interest. When rendered on or near a corresponding location, the density can appear as a “cargo risk column” rising from the location, so that the aerial vehicle 101 or its operator can visualize the risk from the at least one geo-referenced environmental factor as a “virtual object” to avoid in a similar manner to other physical obstacles (e.g., buildings), in one embodiment. In another embodiment, the density can appear as a “cargo risk heat map” on the ground or in the air.

As indicated above, the extent (e.g., density, intensity, toxicity, coverage) of geo-referenced environmental factors can represent the aggregated risk for a given location in the geographic and/or three-dimensional region. For the example, the height and/or any other dimension of the visual representation of the risk data layer can be scaled to be proportional to the calculated risk level for the region. In one embodiment, the height of the risk data layer is a function of time and hence creates a user interface with a dynamic landscape of multiple risk data layers that go “up and down” over the course of the day or other period of time to reflect the frequently changing patterns of the risk function aggregating the extent of the geo-referenced environmental factors for a region of interest that can affect the cargo 102.

In one embodiment, the system 100 also includes a capability to dynamically predict geo-referenced environmental factor data (e.g., in real-time) for a given region based on collecting data from various data sources of human activity in the region, and then using the data to make the predictions of geo-referenced environmental factor data. In one embodiment, dynamic prediction of geo-referenced environmental factor data refers to predicting or estimating the air pollution for a region that can differentiate based on dynamic factors such as but not limited to time (e.g., automobile traffic activity, agricultural activity, etc. with respect to days, weeks, time of day, seasonality) and expected future events (e.g., temperature inversions, calm winds, etc.). The embodiments of dynamic geo-referenced environmental factor data described herein enables dynamic modeling of geo-referenced environmental factor flows in a region of interest so that geo-referenced environmental factors can be determined or predicted with greater temporal granularity.

In another embodiment, the system 100 receives environmental quality data for a geographic and/or three-dimensional region associated with at least one candidate route for the cargo 102 to follow. The environmental quality data indicates at least one geo-referenced environmental factor that negatively affects the cargo so that the cargo cannot be consumed or used in a manner for which the cargo was made or designed. The system 100 then generates a navigation route generated to avoid the at least one geo-referenced environmental factor based on the environmental quality data and provides the navigation route as an output.

In one embodiment, the dynamic geo-referenced environmental factor data along with other risk factors can be used to predict the risk levels to cargo 102 in regions where the cargo will pass through. In other words, the system 100 enables the capability to quantify the risk levels that the cargo 102 may meet on the way by generating a risk data layer or a risk data model of the aggregated risks of regions at a time when the cargo 102 is predicted to pass through the regions. In one embodiment, the system 100 can then route drone 101, and hence the cargo 102, to avoid regions with risk levels above a threshold value or determine a route along which the cargo 102 is expected to pass through a minimum level of risk.

According to another embodiment, the system 100 comprises at least one processor; and at least one memory including computer program code for at least one program, the at least one memory and the computer program code configured to, with the at least one processor, cause the apparatus to: receive data indicating at least one geo-referenced environmental factor that is classified as affecting a cargo that is carried on the navigation route; generate map data representing the at least one geo-referenced environmental factor in a geographic database; and provide the map data for generating the navigation route. The map data is stored in an environmental quality data layer of the geographic database.

It is noted that the aerial vehicle use case is one example application of dynamic geo-referenced environmental factor data. It is contemplated that the embodiments of dynamic geo-referenced environmental factor data described herein can be for any application including but not limited to autonomous vehicles, fleet vehicles, (e.g., delivery vehicles), delivery robots, emergency vehicles, shared vehicles, private vehicles, etc.

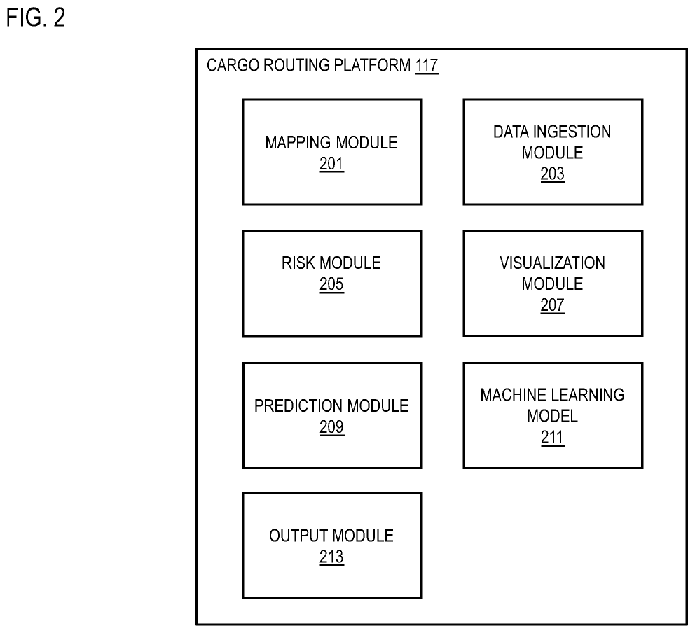

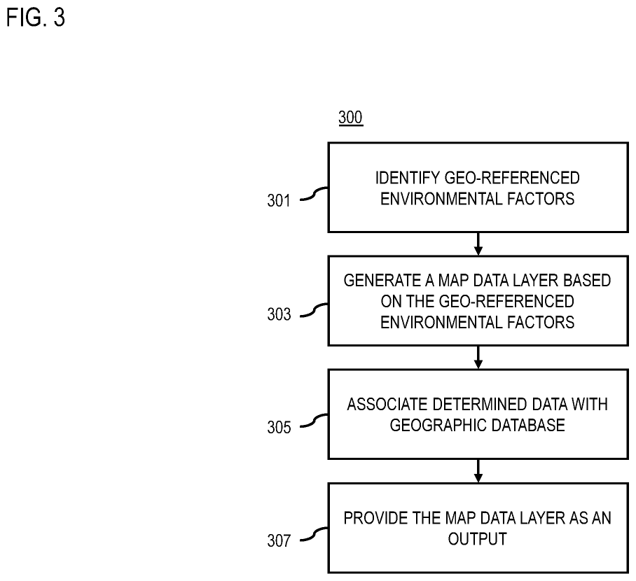

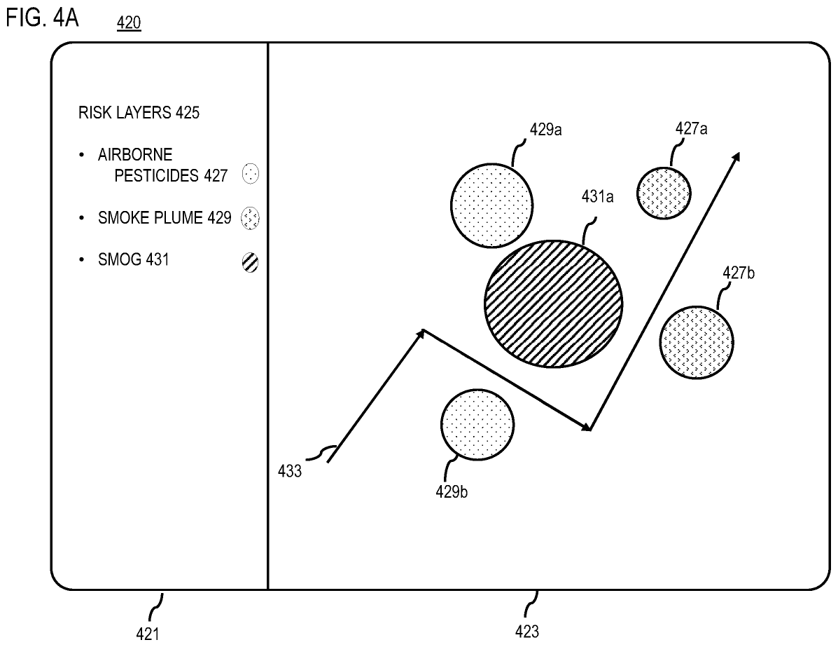

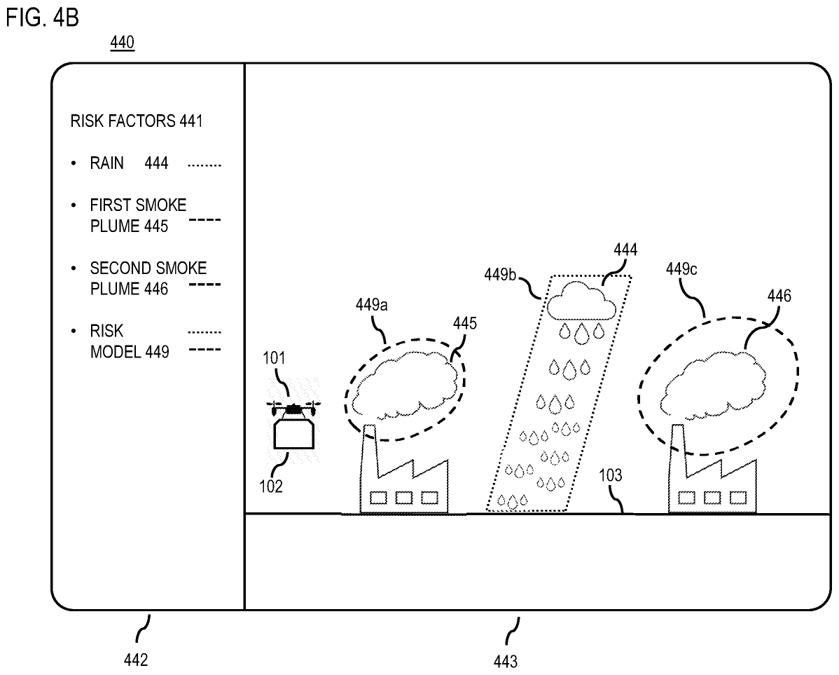

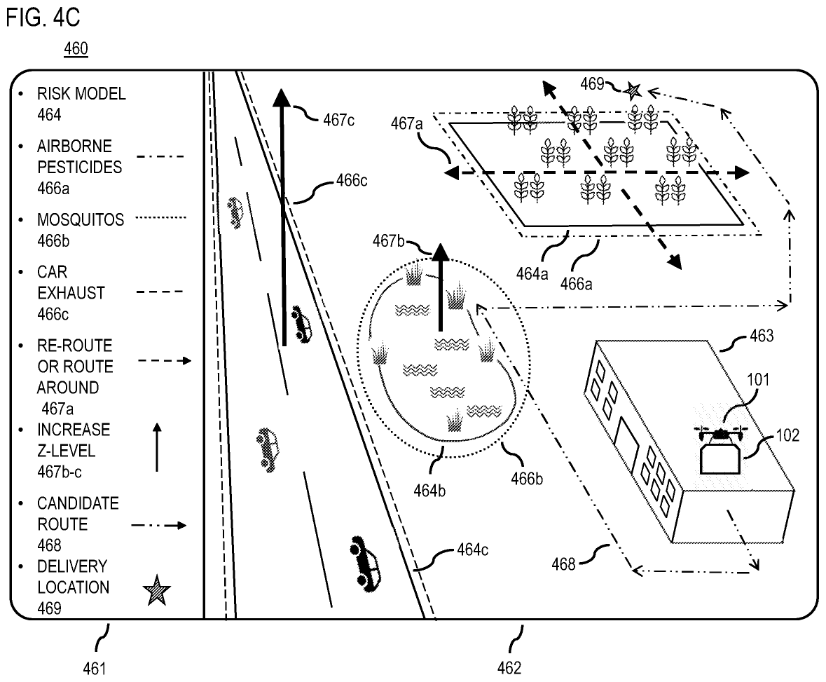

In one embodiment, the cargo routing platform 117 includes one or more components for providing environmental quality data modeling according to the various embodiments described herein. As shown in FIG. 2, the cargo routing platform 117 includes a mapping module 201, a data ingestion module 203, a risk module 205, a visualization module 207, a prediction module 209, a machine learning model 211, and an output module 213. The above presented modules and components of the cargo routing platform 117 can be implemented in hardware, firmware, software, or a combination thereof. It is contemplated that the functions of these components may be combined or performed by other components of equivalent functionality. Though depicted as a separate entity in FIG. 1, it is contemplated that the cargo routing platform 117 may be implemented as a module of any of the components of the system 100 (e.g., a component of the aerial vehicle 101 and/or a client device such UE 107). In another embodiment, the cargo routing platform 117 and/or one or more of the modules 201-213 may be implemented as a cloud-based service, local service, native application, or combination thereof. The functions of these modules are discussed with respect to FIGS. 3-4 below.

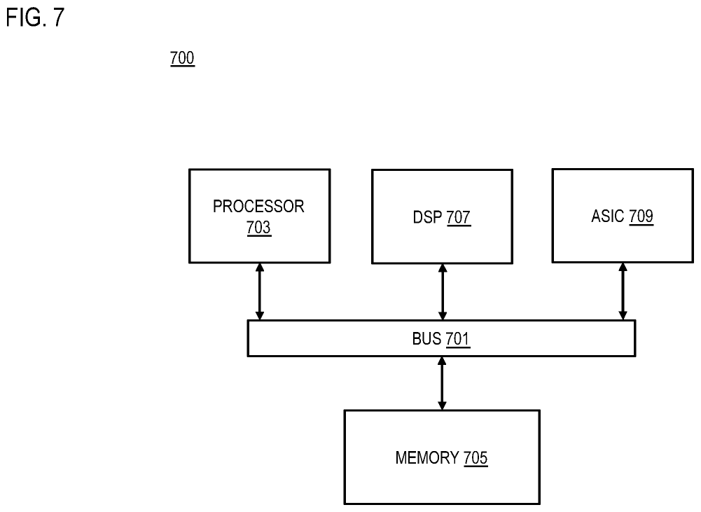

FIG. 3 is a flowchart of a process for mapping geo-referenced environmental factors and generating navigation routes, according to one embodiment. In various embodiments, the cargo routing platform 117, any of the modules 201-213 of the cargo routing platform 117 may perform one or more portions of the process 300 and may be implemented in, for instance, a chip set including a processor and a memory as shown in FIG. 7. As such, the cargo routing platform 117 and/or any of the modules 201-213 of the cargo routing platform 117 can provide means for accomplishing various parts of the process 300, as well as means for accomplishing embodiments of other processes described herein in conjunction with other components of the system 100. Although the process 300 is illustrated and described as a sequence of steps, its contemplated that various embodiments of the process 300 may be performed in any order or combination and need not include all the illustrated steps. More specifically, the process 300 illustrates a process for creating and storing a digital map representing geo-referenced environmental factors for a given geographic or three-dimensional region.

In one embodiment (e.g., in step 301), the mapping module 201 initiates the navigational routing process by identifying geo-referenced environmental factors. It is contemplated that the mapping module 201 can use any means or data sources for identifying the geo-referenced environmental factors. For example, the geo-referenced environmental factors can be determined by sending out dedicated mapping vehicles or drones to identify potential environmental factors and their corresponding characteristics such as but not limited to location, density and/or intensity. These mapping vehicles or drones can also be equipped with sensors (e.g., LIDAR, RADAR, cameras, etc.) to map or record the environmental factors and their characteristics (e.g., as high-resolution mesh point cloud data, 3D models, image data, etc.). The mesh or model data can be a polygonal or other mathematical representation of the environmental factor that are mapped to geographic coordinates to provide geographically accurate representations of the environmental factors. The mesh or model data can then be included as part of digital map data representing geo-referenced environmental factors in the geographic database 121. In addition or alternatively, the mapping module 201 can query or process available blueprints, diagrams, databases (e.g., county databases of agricultural or industrial zones, local air quality databases), etc. to identify potential environmental factors.

In another embodiment, in step 301, the risk module 205 receives map data indicating geo-referenced environmental factors over a geographic and/or three-dimensional region. In one embodiment, the data ingestion module 203 retrieves real-time data, historical data, or a combination thereof indicating the spatial concentration of the geo-referenced environmental factors, and calculates the spatial concentration based on the real-time data, the historical data, or a combination thereof

According to an embodiment, geo-referenced environmental factor data can be collected and stored as a data layer or other record of the geographic database 121. It is contemplated that real-time geo-referenced environmental factor data can be collected and/or stored alone or in combination with the digital map data of geo-referenced environmental factors. In one embodiment, the data ingestion module 203 can query the real-time geo-referenced environmental quality data from external databases or services providing the data (e.g., the services platform 111, services 113, content providers 115, etc.). In another embodiment, the data ingestion module 203 can determine the real-time geo-referenced environmental quality data from external databases or services providing environmental quality data.

By way of example, in cases where geo-referenced environmental factors include airborne pollutants, wind data is critically important in generating or mapping a navigation route. The data ingestion module 203 can monitor wind speeds and directions, or wind vectors, as part of the collected real-time data. Such data can be determined and/or predicted from weather data (e.g., queried from a weather service).

In another embodiment, the data ingestion module 203 can sense, determine, retrieve, and/or query a geographic database 121 or equivalent for the any of the geo-referenced environmental factor data. For example, the probability of ultraviolet light (UV) damage to cargo 102 can be calculated by the risk module 205 according to geo-referenced environmental factor data located in the geographic database 121, such data including but not limited to historical UV index values, which may further include data on time of day, angle of the sun to the earth, weather conditions, and elevation.

The geographic or three-dimensional region in which cargo 102 may be affected by a geo-referenced environmental factor is represented by a risk zone. For example, the risk zone can be defined as a circle, cloud, any other shape, any color and/or any pattern (e.g., rectilinear polygon, dome, Voronoi shape, hatch marks, dot patterns, etc.) forming a location of the geo-referenced environmental factor.

In step 303, the prediction module 209 generates a map data layer of a geographic database based on the density and/or intensity of a geo-referenced environmental factor. In one embodiment, the type of shape for a risk zone is represented by or corresponding type of geo-referenced environmental factor density and/or intensity. By way of example, a rectangular-shaped risk zone may indicate the location of radioactive, or ionizing, radiation while its color, green, may indicate a relatively safe radioactivity level. In another example, a circle-shaped risk zone may indicate the location of mosquitos that carry West Nile virus while its color, yellow, may indicate a high density of mosquitos in that risk zone.

FIG. 4A is a diagram of a user interface illustrating spatial concentrations of geo-referenced environmental factors, according to one embodiment. In FIG. 4A, the user interface (UI) 420 includes a first element 421 for presenting information on different risk layers 425 and a second element 423 for presenting spatial concentrations of different geo-referenced environmental factors. For example, the first element 421 lists different risk data layers 425 for different geo-referenced environmental factors, such as airborne pesticides 427, smoke plume 429, smog 431, etc. FIG. 4A shows two airborne pesticide zones 427a and 427b, two smoke plume zones 429a and 429b, and one smog zone 431a on the UI 420.

By way of another example, based on thresholds for the densities and/or intensities of geo-referenced environmental factors in risk zones in the geographic and/or three-dimensional region, the risk module 205 determines a pattern for the circles or other shapes that indicate the type of geo-referenced environmental factor in a risk zone, while the sizes of the circles or other shapes reflect the intensity of the geo-referenced environmental factor. In one embodiment (e.g., FIG. 4A), the visualization module 207 generates a representation of the risk zones of all types of geo-referenced environmental factors. In another embodiment, the visualization module 207 generates a representation of the risk zones as a risk data layer per type of geo-referenced environmental factors.

In one embodiment, the visualization module 207 can use a trained machine learning model 211 or equivalent to predict a risk level for a given zone based on the aggregated geo-referenced environmental factors of the region. For example, the trained machine learning model 211 can be trained using aggregated ground truth risk-related data that has been labeled or annotated with a known or ground-truth risk level. The risk factors aggregated from the geographic and/or three-dimensional region can be used as input features to the trained machine learning model 211 to output a risk level prediction and optionally a corresponding confidence level of the prediction.

Ideally, for trip planning, a pilot/controller would pick a route which has no risk volume or risk data layer on the flight path (e.g., no crossing of any rendered risk zone). By way of example, the flight path 433 can be drawn or computed to avoid passing through any 3D risk zones of one or more of the risk data layers, to minimize safety risks over the flight path 433. In one embodiment, a risk zone is avoided horizontally by flying around on the same plane. In another embodiment, a risk zone is avoided vertically by flying at a different altitude/height. The mapping module 201 can determine a required altitude change based on the data model representing the coverages of the geo-referenced environmental factors in combination with terrain data for the geographic and/or three-dimensional region. In one embodiment, the mapping module 201 retrieves a ground elevation or equivalent terrain data of a location that the aerial vehicle 101 is to fly over or to approach within a distance threshold. This ground elevation or terrain data can be retrieved from, for instance, the geographic database 121 or other equivalent data store providing ground elevation data. The mapping module 201 can then interact with the prediction module 209 to predict the type of geo-referenced environmental factors (e.g., air pollution) that may be encountered according to the embodiments described herein. Based on the prediction, the risk module 205 determines a region of geo-referenced environmental factors that would affect cargo 102 passing through. By way of example, using the ground elevation data and determined range of the geo-referenced environmental factor, the mapping module 201 can determine an altitude or altitude change (e.g., how much higher the aerial vehicle has to fly on a route relative to a route on which no geo-referenced environmental factors is expected or predicted) to generate on a route over the location. For example, if a location has a ground elevation of 30 meters above sea level and the cargo routing platform 117 predicts that a geo-referenced environmental factor such as a plume of smoke from an incinerator at 25 meters above ground level is expected at a location, the cargo routing platform 117 can generate a route that takes an aerial vehicle 101 carrying that cargo 102 at least 55 meters high (e.g., ground elevation plus elevation of geo-referenced environmental factor above ground) to avoid being within range of the smoke plume. In one embodiment, the mapping module 201 can add a safety margin to the recommended altitude, for instance, by applying a multiplicative factor to the range of the geo-referenced environmental factor (e.g., a factor of 1.5 times so that in the example above the altitude would be 67.5 meters based on a ground elevation of 30 meters plus 1.5× the 25 meter elevation above ground level of the smoke plume).

If a risk zone cannot be avoided, the pilot/controller could then take the route with the lowest risk to cargo 102 (e.g., crossing risk zones with lower risk levels). This is especially useful when the pilot/controller needs to adapt to changing conditions while flying (e.g., during rerouting of a flight path) as the pilot will need to make very quick decisions on-the-fly.

In one embodiment, the cargo routing platform 117 uses an ability of a computer program (or software) or a neural network (artificial intelligence) of the aerial vehicles 101 to create an optimal delivery route, react in real-time and/or reroute (or recreate route) the aerial vehicles 101 and hence their cargo 102, based on historical and real-time data and intelligence combined with real-time edge decision (such as split-decision, decision-point, cloud-decision) making at critical decision points for ensuring success of deliveries.

FIG. 4B is a diagram illustrating an example of a geo-referenced environmental factors risk data model, according to one embodiment. In one embodiment, the risk module 205 determines the cargo 102 and the geo-referenced environmental factors, and the visualization module 207 generates the representation of a geo-referenced environmental factors risk data model that considers a vertical 3D risk zone of a geo-referenced environmental factors.

In FIG. 4B, the UI 440 includes a first element 442 for presenting information on different geo-referenced environmental factors and a second element 443 for presenting a risk data model. For example, the first element 442 lists different risk factors 441, such as geo-referenced environmental factors rain 444, first smoke plume 445, and second smoke plume 446.

In the embodiment illustrated by FIG. 4B, the cargo routing platform 117 determines the cargo and presents the distributions of different geo-referenced environmental factors in a given geographic and/or three-dimensional region as a risk model 449, associated with a time required for the cargo 102 to travel through the geographic and/or three-dimensional region. For example, the risk model 449 includes a first smoke plume 445 from a power plant, a rain 444, and a second smoke plume 446 from a second power plant. In an embodiment, the risk models 449a-c simultaneously indicate the type of geo-referenced environmental factor as well as that factor's density and/or intensity. In this example, the risk models 449a and 449c indicate man-made geo-referenced environmental factors with its oval shape and smoke plumes by using dashed lines. The risk model 449b indicates a natural geo-referenced environmental factor with its parallelogram shape and a rain event by using a dotted line. In this example, the smoke plume 446 contains a higher density of soot and toxic chemicals, and therefore a higher risk to damaging cargo 102, than the smoke plume 445, which is indicated by risk model 449c's oval shape being larger than risk model 449a's oval shape. The cargo 102 can avoid the risk data model 449 in a similar manner to physical obstacles (e.g., buildings). As mentioned, a risk data model is a three-dimensional (3D) model that indicates a probability of encountering a geo-referenced environmental factor that can damage cargo 102. It is noted that the embodiment of FIG. 4B is provided by way of illustration an example embodiment and not as limitations.

FIG. 4C is a perspective diagram illustrating an example of a geo-referenced environmental factors risk data model, according to one embodiment. In one embodiment, the risk module 205 determines the cargo 102 and the geo-referenced environmental factors, and the visualization module 207 generates the representation of a geo-referenced environmental factors risk data model that considers a vertical 3D risk zone of a geo-referenced environmental factors.

In FIG. 4C, the UI 460 includes a first element 461 for presenting information on risks associated with geo-referenced environmental factors 466a-c, navigation route adjustments 467a-c, the candidate route 468, and a delivery point 469. The UI 460 includes a second element 462 for presenting a risk data model 464.

In the embodiment illustrated by FIG. 4C, the cargo routing platform 117 determines the cargo and presents the distributions of different geo-referenced environmental factors in a given geographic and/or three-dimensional region as risk model 464, associated with a time required for the cargo 102 to travel through the geographic and/or three-dimensional region. For example, the risk model includes a crop field 464a, a pond 464b, and a road 464c. In an embodiment, the risk models 466a-c indicate the type of geo-referenced environmental factor as well as the region within which a factor may affect the cargo 102. In this example, the risk model 466a indicates with a dash-dot line the presence of airborne pesticides. The risk model 466b indicates with a dotted line the presence of mosquitos carrying an infectious disease. The risk model 466c indicates with dashed lines the presence of car exhaust. In this example, the risk model 464 indicates navigation route adjustments 467a and 467b. Adjustment 467a specifies that the aerial vehicle 101, and hence the cargo 102, route around the risk model 466a indicating airborne pesticides. Adjustment 467b and 467c specifies that the aerial vehicle 101, and hence the cargo 102, fly at an increased altitude, or increased z-level, in order to avoid risk model 466b indicating mosquitos and risk model 466c indicating car exhaust. In an embodiment, the adjustments 467a-c are visualized in the UI 460 with the direction, length and width of arrows indicating direction, speed of adjustment, and magnitude of adjustment respectively. Other shapes, patterns, colors, and/or symbols that may be used to indicate adjustments 467a-c are readily apparent to one of ordinary skill in the art.

In FIG. 4C, according to one embodiment, the risk model 464 includes a candidate route 468 for the aerial vehicle 101 and its cargo 102 to follow. Risk model 464 further includes delivery location 469 at the end of candidate route 468. The aerial vehicle 101 and its cargo 102 begins its candidate route on the roof of a warehouse 463. The cargo routing platform 117 determines a candidate route 468 after determining geo-referenced environmental factors. In another embodiment, the cargo routing platform 117 may determine a candidate route 468 without determining geo-referenced environmental factors. The cargo 102 can avoid risk model 464 in a similar manner to physical obstacles (e.g., buildings). A risk data model is a three-dimensional (3D) model that indicates a probability of encountering geo-referenced environmental factors that can damage cargo 102. It is noted that the embodiment of FIG. 4C is provided by way of illustration an example embodiment and not as limitations.

In one embodiment, the prediction module 209 creates a data model representing a density and/or intensity of geo-referenced environmental factors. In one instance, the map data layer further includes the data model. In another instance, the data model includes the map data layer.

In step 305, the mapping module 201 associates the determined geo-referenced environmental factors with a geographic database 121. In one embodiment, “associating” refers, for instance, to storing a data record representing the geo-referenced environmental factors in the digital map data stored in the geographic database 121. For example, the geo-referenced environmental factor data record can include data fields such as but not limited to an environment factor description or type, types of cargo affected by the environmental factor, geographic extent of the environmental factor, etc. In one embodiment, the environmental factor data record can be referenced to specific node/link data records of the digital map data of the geographic database 121. In one embodiment, the data records representing the geo-referenced environmental factors can be incorporated as additional records of the geographic database 121. Alternatively, the geo-referenced environmental factor data records can be stored as a separate data layer of the geographic database 121. A data layer, for instance, groups the data records of the geo-referenced environmental factors as a discrete and severable subset of digital map data of the geographic database 121. In this way, the system 100 can deliver or publish the geo-referenced environmental factors data records as a separate map data layer from the other data of the geographic database 121 (e.g., to facilitate delivery of the map data layer only to those devices that are requesting the data to reduce the map data size for those devices that do not request the map data layer).

In step 307, the mapping module 201 provides the map data layer as an output. By way of example, the mapping module 201 routes an aerial vehicle over the geographic and/or three-dimensional region based on the map data layer. The route can be determined using any routing engine known in the art based on an origin and destination specified by a pilot/controller of the aerial vehicle 101 for the route at a given time (e.g., expected start time of the route). In one embodiment, the aerial vehicle is a delivery drone, and wherein the determined route is configured to pass through a geo-referenced environmental factor.

Ideally, for route planning, a pilot/controller would pick a route which does not cross any risk zone. If that is not possible, the pilot could then take the route with the lowest risk (e.g., crossing objects with lower risk levels). This is especially useful when the pilot/controller needs to adapt to changing conditions while flying (e.g., during rerouting of a flight path) as the pilot will need to make very quick decisions on-the-fly.

In one embodiment, the mapping module 201 determines a route over the geographic and/or three-dimensional region based on the data model representing the densities and/or intensities of the geo-referenced environmental factors in combination with terrain data for the geographic and/or three-dimensional region. The densities and/or intensities of geo-referenced environmental factors may include real-time environmental quality data, and the mapping module 201 calculates a real-time routing instruction based on the real-time environmental quality data.

In another embodiment, the real-time routing instruction is calculated by a local component of the aerial vehicle for real-time use by the aerial vehicle.

In one embodiment, the route is calculated using a cost function based on minimizing a probability of the aerial vehicle encountering geo-referenced environmental factors over the geographic and/or three-dimensional region. By way of example, the probability considers the density and/or intensity of the geo-referenced environmental factors, the terrain data for the geographic and/or three-dimensional region, other risk factors as discussed, etc.

In one embodiment, the data model further indicates a predicted damage level to the aerial vehicle, a payload of the aerial vehicle, or a combination thereof that is calculated to be inflicted by the geo-referenced environmental factors, and the routing is further based on the predicted damage level.

In one embodiment, the prediction module 209 or the local component of the aerial vehicle calculates a probability of encountering at least one geo-referenced environmental factor while on the navigation route based on the environmental quality data, and the mapping module 201 initiates an activation of at least one sensor of the aerial vehicle performing the navigation route. For instance, the at least one sensor is configured to collect sensor data for determining a presence of the at least one geo-referenced environmental factor, such as a camera, a LIDAR system, and/or air-quality sensor for detecting and/or measuring the at least one geo-referenced environmental factor, etc. In one embodiment, the sensor data is used to update the environmental quality data, map data associated with the at least one geo-referenced environmental factor, or a combination thereof, such as one or more LIDAR systems detecting materials of the at least one geo-referenced environmental factors, etc.

In another embodiment, based on the probability of encountering at least one geo-referenced environmental factor while one the navigation route, the mapping module 201 or the local component of the aerial vehicle initiates an evasive maneuver by the aerial vehicle based on determining that probability is greater than a threshold probability. By way of example, the aerial vehicle flies above, around, or below the one or more risk zones in the data model. In another example, the aerial vehicle flies via the one or more risk zones faster than a threshold reachable by the at least one geo-referenced environmental factor.

In another embodiment, based on the probability of encountering at least one geo-referenced environmental factor while on the navigation route, the mapping module 201 or the local component of the aerial vehicle 101 determines whether to instruct the aerial vehicle 101 to complete a delivery of cargo 102 in the geographic and/or three-dimensional region based on the map data layer. By way of example, when the risk is too high or the risk region is very big (e.g., city riots, terrorist attacks, wars, etc.), the aerial vehicle may be instructed to cancel the delivery.

In other embodiments, the mapping module 201 further considers non-environmental risk factors, such as drone-disabling instruments (e.g., slingshots, guns, thrown rocks), interfering radio signals, network (e.g., cellular network) coverage, aviation-related data (e.g., air traffic, etc.), etc. The non-environmental risk factors can be considered independent from the at least one geo-referenced environmental factor to determine a map data layer of a geographic database on their own.

In one embodiment, the mapping module 201 receives cargo data (e.g., the type of goods being delivered, the packaging of the goods) and environmental quality data and generates a map indicating the density and/or intensity of at least one geo-referenced environmental factor over a geographic and/or three-dimensional region, generates a route over the geographic and/or three-dimensional region with one or more attitude changes based on map data, and configures an aerial vehicle to fly the route. The route can be generated by minimizing a probability of the cargo 102 encountering the one or more geo-referenced environmental factors. By way of example, the data includes, but is not limited to, air quality data, historical data of agricultural activity, wind data, weather data, solar flare data, or a combination thereof.

In another embodiment, the mapping module 201 calculates a probability of encountering at least one geo-referenced environmental factor while on the navigation route based on the environmental quality data and initiates an activation of at least one sensor of the aerial vehicle 101. The at least one sensor is configured to collect sensor data for determining a presence or measuring the at least one geo-referenced environmental factor. In yet another embodiment, the mapping module 201 uses the sensor data to update the map data indicating the density and/or intensity of the at least one geo-referenced environmental factor, such as one or more air quality sensors detecting and/or measuring the density of the geo-referenced environmental factor (e.g., carbon monoxide, sulfur dioxide, nitrogen dioxide, ozone, particulate matter, lead, benzene, perchloroethylene, methylene chloride), etc.

In yet another embodiment, the mapping module 201 calculates a probability of encountering at least one geo-referenced environmental factor based on the environmental quality data and initiates an evasive maneuver by the aerial vehicle 101 based on determining that probability is greater than a threshold probability. By way of example, the aerial vehicle 101 flies above, around, or below the one or more risk zones in the data model. In another example, the aerial vehicle 101 flies via the one or more risk zones faster than a threshold reachable by the one or more risk factors. In yet another example, the aerial vehicle flies via the one or more risk zones in a pattern, in or near a shelter, or a combination thereof, to dodge the one or more risk factors mapped in the one or more risk zones.

In one embodiment, electromagnetic field data can be sensed using sensors located on aerial vehicles 101, in the infrastructure (e.g., smart city infrastructure), and/or from any other sensor in the region of interest. In addition or alternatively, historical or previously sensed electromagnetic data that has been stored for the regions of interest along the navigation route can be stored and retrieved from the geographic database 121. Data on the absence of GPS or other location signals in the regions of interest can also be sensed or retrieved from the geographic database 121. Regions with no or low GPS reception or equivalent (e.g., regions with high multi-path signal interference) can cause the aerial vehicle 101 to have inaccurate positioning information. Weather data (e.g., winds or other weather conditions) can be retrieved from weather services or applications provided by the services platform 111 and/or any of the services 113a-113n. Wind or weather conditions that exceed the operational capability of the aerial vehicle 101 can cause the aerial vehicle 101 to be more susceptible to being blown off course or into other objects, or from weather related damage (e.g., lightning strikes, hail damage, snow, etc.). Network coverage data can be retrieved from the communication network 109, services platform 111, and/or services 113a-113n. Network coverage data can include cellular or other data network signal strength or availability. Losing communications connections between the aerial vehicle 101 and a corresponding remote pilot, remote operator, or remote data service can increase safety risks. Finally, aviation-related data such as air traffic, flight restrictions, etc. can be retrieved from the services platform 111, services 113a-113n, and/or geographic database 121. By way of example, increased air traffic in the geographic can increase safety risks of colliding with other aerial vehicles.

It is noted that the above risk factors are provided by way of illustration and not as limitations. It is contemplated that data on any other location-based geo-referenced environmental factor that can affect an aerial vehicle's cargo over a region of interest can be sensed/retrieved and incorporated into the risk data layer and/or the risk data model according to the described embodiments.

Visualization or rendering of the risk data layer could be offered on a plurality of user interfaces for various purposes including but not limited to: (1) an application for trip planning (e.g., on a desktop computer or device); (2) an augmented reality (AR) view for live visualization by the pilot, co-pilot, and/or any other user; (3) an on-device dashboard interface; (4) an autonomous system use (e.g., for a pilot/controller of the aerial vehicle 101, other data post processing uses, etc.); and/or the like.

In one embodiment, as described above, the calculated risk levels for the regions of interest can be time sensitive. In other words, the level of risk can be a function of time by updating the environmental quality data collected from the regions of interest in real-time, continuously, periodically, according to a schedule, or a combination thereof. The updated environmental quality data or risk factors can then be used to update the risk data layer and/or the risk data model associated with the flight path. In this way, the visualization module 207 can dynamically adjust at least one dimension (e.g., height) of the risk data layer/model as function of time.

The embodiments of visualizing risk levels or aerial vehicle flights described herein provide several advantages. For example, quickly presenting or displaying risks makes aerial flights safer. The unique visualization also is more convenient and efficient for pilots/controllers to plan flying journeys. The intuitive presentation also enables faster reaction time for pilots/controllers who need to react to changing conditions during a flight. As another advantage, the embodiments of risk data layers/models which is often invisible to the naked eye.

Although the various embodiments are discussed with respect to aerial flights, it is contemplated that the embodiments for visualizing risk levels can be used for other applications such as but not limited to off-road travel, optimizing traffic flows, determining insurance coverage, and/or any other application where aggregated risks are to be visualized.

The geographic and/or three-dimensional region can include any location or region for which geo-referenced environmental factors are to be predicted. The region can be specified as a point location with a surround radius, as a bounded region, etc. The region of interest can also be specified as a point of interest (e.g., a building, structure, park, etc.) or geopolitical boundary (e.g., neighborhood, city, state, region, country, etc.). In one embodiment, the data ingestion module 203 retrieves or otherwise determines industrial-activity data for the location. The industrial-activity data includes any data that can be sensed, reported, recorded, stored, etc. that is associated with or indicative of any industrial activity producing geo-referenced environmental factors within the region of interest. As an example, the data ingestion module 203 can determine the industrial-activity data from any of a plurality of data sources. These data sources can be provided, for instance, by the services platform 111, services 113a-113n (also collectively referred to as services 113), content providers 115a-115m (also collectively referred to as content providers 115), and/or equivalent platforms. By way of example, the plurality of data sources can include but is not limited to any combination or subset of:
Online industrial activity data;
Positioning data from a mobile device in events (e.g., UE 107);
Traffic data near industrial activity;
NASA air quality tracking data; and
Municipal industrial-activity data.

In one embodiment, input features can be extracted from the industrial-activity data to support geo-referenced environmental factor prediction according to the embodiments described herein and then processed using the machine learning model 211.

In one embodiment, the prediction of geo-referenced environmental factors is generated based on a trained machine learning model 211. The trained machine learning model 211, for instance, is trained using ground truth data correlating reference historical industrial-activity data to ground truth geo-referenced environmental factor data. Accordingly, in one embodiment, the data ingestion module 203 can acquire ground truth data from one or more locations that are like expected regions of interest. The ground truth data, for instance, correlates reference historical geo-referenced environmental factor data to ground truth geo-referenced environmental factor data. Reference historical geo-referenced environmental factor data includes one or more input data sources with known values or parameters. The set of known geo-referenced environmental factor data values can be referred to as ground truth input feature sets. These feature sets can then be labeled with ground truth geo-referenced environmental factor data that reflects known geo-referenced environmental factor data or geo-referenced environmental factor data that has been accepted or otherwise treated as the true geo-referenced environmental factor data of a region exhibiting the reference geo-referenced environmental data values.

As discussed above, the machine learning model 211 uses training or ground truth data to automatically “learn” or detect relationships between different input feature sets and then output predicted geo-referenced environmental factors based on those feature sets. In one embodiment, at least one of the input features or values includes a temporal parameter that indicates the times at which the ground input feature sets and corresponding ground truth geo-referenced environmental factors was collected or determined. In this way, the trained machine learning model 211 can include time as a dynamic parameter so that the machine learning model 211 can learn the relationship between geo-referenced environmental factors and time. For example, the dynamic parameter can provide for the prediction of the geo-referenced environmental factors with respect to a time of day, a day, a week, a season, a year, or a combination thereof.

In one embodiment, the machine learning model 211 can be trained using the acquired ground truth training data set. For example, the cargo routing platform 117 can incorporate a supervised learning model (e.g., a logistic regression model, Random Forest model, and/or any equivalent model) to provide feature matching probabilities that are learned from the training data set. For example, during training, the prediction module 209 uses a learner module that feeds input feature sets from the ground truth training data set into the machine learning model 211 to compute a predicted geo-referenced environmental factor using an initial set of model parameters. The learner module then compares the predicted matching probability of the predicted geo-referenced environmental factor feature to the ground truth geo-referenced environmental factor data for each input feature set in the ground truth training data set. The learner module then computes an accuracy of the predictions for the initial set of model parameters. The prediction of the geo-referenced environmental factor can then be further based on the relative weighting information among the input features to train the machine learning model 211.

To use the trained machine learning model 211 to make predictions, the prediction module 209 selects or receives an input for selecting a time for which the environmental quality data density and/or intensity prediction is to be made. The selected time can be any time in the future or the past. For example, in an aerial vehicle 101 use case, a future time can be selected to correspond to when the aerial vehicle 101 is expected to arrive or fly over the selected region of interest to assist in assessing the risk to cargo 102 with a geographic and/or three-dimensional region.

In one embodiment, after generating the dynamic prediction, the output module 213 can generate a visual representation of the geo-referenced environmental factors. Examples of such a visual representation is shown in FIGS. 4A-4B.

Returning to FIG. 1, as shown, the system 100 comprises an aerial vehicle 101 equipped with a variety of sensors that is capable operating in airspaces overpopulated or unpopulated regions. In one embodiment, the aerial vehicle 101 can fly or otherwise operate autonomously or under direct control via the UE 107 that may include or be associated with one or more software applications 119 supporting routing based on risk level predictions and/or visualizations according to the embodiments described herein. As previously discussed, the system 100 further includes cargo routing platform 117 coupled to the geographic database 121, wherein the cargo routing platform 117 performs the functions associated with visualizing risk levels, providing dynamic airborne pesticide density prediction, and/or aerial vehicle routing as discussed with respect to the various embodiments described herein. In one embodiment, the aerial vehicle 101, cargo routing platform 117, UE 107, and other components of the system 100 have connectivity to each other via the communication network 109.

In one embodiment, the aerial vehicle 101 can operate autonomously or via a remote pilot using UE 107 to fly the aerial vehicle 101 or configure a flight path or route for the aerial vehicle 101. In one embodiment, the aerial vehicle 101 is configured to travel using one or more modes of operation over airborne pesticide or unpopulated regions. The aerial vehicle 101 many include any number of sensors including cameras, recording devices, communication devices, etc. By way example, the sensors may include, but are not limited to, a global positioning system (GPS) sensor for gathering location data based on signals from a positioning satellite, Light Detection And Ranging (LIDAR) for gathering distance data and/or generating depth maps, a network detection sensor for detecting wireless signals or receivers for different short-range communications (e.g., Bluetooth®, Wireless Fidelity (Wi-Fi), Li-Fi, Near Field Communication (NFC), etc.), temporal information sensors, a camera/imaging sensor for gathering image data, and the like. The aerial vehicle 101 may also include recording devices for recording, storing, and/or streaming sensor and/or other telemetry data to the UE 107 and/or the cargo routing platform 117 for mapping or routing.

In one embodiment, the aerial vehicle 101 is capable of being configured with and executing at least one route based on visualized risk levels, dynamic airborne pesticide density predictions according to the embodiments described herein. The aerial vehicle 101 can also be configured avoid regions with high risk levels, populated regions, objects, and/or obstructions. In addition, the aerial vehicle 101 can be configured to observe restricted paths or routes. For example, the restricted paths may be based on governmental regulations that govern/restrict the path that the aerial vehicle 101 may fly (e.g., Federal Aviation Administration (FAA) policies regarding required distances between objects). In one embodiment, the system 100 may also consider one or more pertinent environmental or weather conditions (e.g., rain, water levels, sheer winds, etc. in and around underground passageways and their entry/exit points) in determining a route or flight path.

In one embodiment, the aerial vehicle 101 may determine contextual information such as wind and weather conditions in route that may affect the aerial vehicle 101's ability to follow the specified route and then relay this information in substantially real-time to the system 100. In one embodiment, the aerial vehicle 101 may request one or more modifications of the flight path based, at least in part, on the determination of the contextual information or a change in the real-time calculated risk levels over regions of interest (e.g., newly detected or updated risk factors causing a sudden and unexpected change in risk levels). In one embodiment, the system 100 creates a data object to represent the navigation route and may automatically modify the route data object based on receipt of the contextual information from the aerial vehicle 101 or another source and then transmit the new route object to the aerial vehicle 101 for execution. In one embodiment, the aerial vehicle 101 can determine or access the new route data object and/or determine or access just the relevant portions and adjust its current path accordingly. For example, if multiple highly dense airborne pesticide regions (e.g., buildings) are encountered, the system 100 may condense the width of the aerial vehicle 101′s flight path to better ensure that the aerial vehicle 101 will avoid the highly dense airborne pesticide regions.

By way of example, a UE 107 is any type of dedicated aerial vehicle control unit, mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that a UE 107 can support any type of interface to the user (such as “wearable” circuitry, etc.). In one embodiment, a UE 107 may support any type of interface for piloting or routing the aerial vehicle 101. In addition, a UE 107 may facilitate various input means for receiving and generating information, including, but not restricted to, a touch screen capability, a keyboard and keypad data entry, a voice-based input mechanism, and the like. Any known and future implementations of a UE 107 may also be applicable.

By way of example, the UE 107 and/or the aerial vehicle 101 may execute applications 119, which may include various applications such as a risk visualization application, an aerial routing application, a location-based service application, a navigation application, a content provisioning application, a camera/imaging application, a media player application, an e-commerce application, a social networking application, and/or the like. In one embodiment, the applications 119 may include one or more feature applications used for visualizing risk levels according to the embodiments described herein. In one embodiment, the application 119 may act as a client for the cargo routing platform 117 and perform one or more functions of the cargo routing platform 117. In one embodiment, an application 119 may be considered as a Graphical User Interface (GUI) that can enable a user to configure a route or flight path for execution by aerial vehicle 101 according to the embodiments described herein.

In one embodiment, the communication network 109 of system 100 includes one or more networks such as a data network, a wireless network, a telephony network, or any combination thereof. It is contemplated that the data network may be any local region network (LAN), metropolitan region network (MAN), wide region network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof

In one embodiment, the cargo routing platform 117 can interact with the services platform 111 to receive data (e.g., airborne pesticide density data from a plurality of data sources.) for providing routing or operation of the aerial vehicle 101 based on dynamic airborne pesticide density predictions. By way of example, the services platform 111 may include one or more services 113 for providing content (e.g., agricultural activity data, ground truth data, etc.), provisioning services, application services, storage services, mapping services, navigation services, contextual information determination services, location-based services, information-based services (e.g., weather), etc. In one embodiment, the services platform 111 may interact with the aerial vehicle 101, UE 107, and/or cargo routing platform 117 to supplement or aid in providing dynamic airborne pesticide density predictions.

By way of example, the aerial vehicle 101, UE 107, cargo routing platform 117, and the services platform 111 communicate with each other and other components of the system 100 using well known, new or still developing protocols. In this context, a protocol includes a set of rules defining how the network nodes within the system 100 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a protocol, and (2) payload information that follows the header information and contains information that may be processed independently of that protocol. In some protocols, the packet includes (3) trailer information following the payload and indicating the end of the payload information. The header includes information such as the source of the packet, its destination, the length of the payload, and other properties used by the protocol. Often, the data in the payload for the protocol includes a header and payload for a different protocol associated with a different, higher layer of the OSI Reference Model. The header for a protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

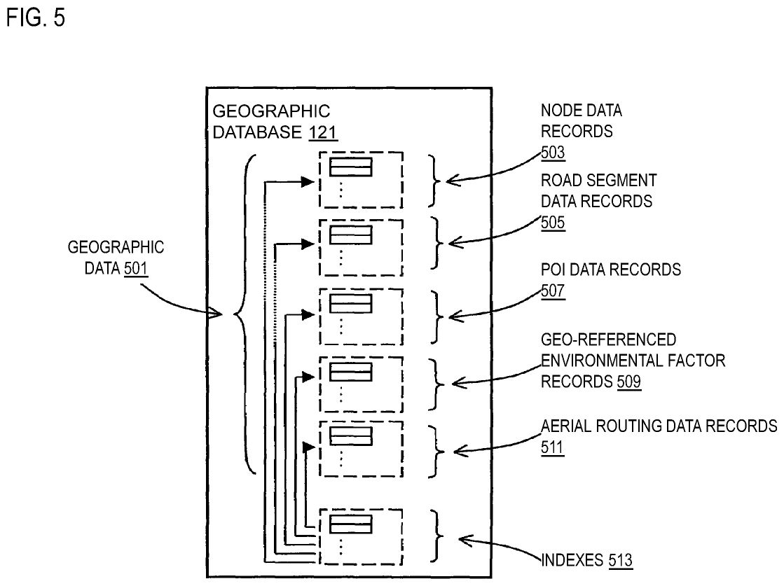

FIG. 5 is a diagram of a geographic database 121 capable of storing map data for environmental quality data density and/or intensity predictions, according to one embodiment. In one embodiment, the geographic database 121 includes geographic data 501 used for (or configured to be compiled to be used for) mapping and/or navigation-related services, such as for routing aerial vehicles based on geo-referenced environmental factors density data to create a 3D flightpath or route.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the geographic database 121.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior region of an outer boundary formed by a string of oriented links that begins and ends in one node. In one embodiment, a simple polygon does not cross itself.

“Polygon”—A region bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 121 follows certain conventions. For example, links do not cross themselves and do not cross each other except at a node. Also, there are no duplicated shape points, nodes, or links. Two links that connect each other have a common node. In the geographic database 121, overlapping geographic features are represented by overlapping polygons. When polygons overlap, the boundary of one polygon crosses the boundary of the other polygon. In the geographic database 121, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic data 501 of the database 121 includes node data records 503, road segment or link data records 505, POI data records 507, geo-referenced environmental factor data records 509, aerial routing data records 511, and indexes 513, for example. More, fewer or different data records can be provided. In one embodiment, additional data records (not shown) can include but are not limited to cartographic (“cartel”) data records, routing data, and maneuver data. As previously discussed, in some embodiments, the geo-referenced environmental factor data records 509 can be mapped to an airspace (e.g., an airspace in which aerial vehicles 101 are operating). Accordingly, the geographic database 121 can include additional cartographic data records (not shown) that map or provide map coordinates (or equivalent map representations) of the airspace volumes corresponding to, affected by, and/or otherwise exhibiting the environmental factors indicated in the geo-referenced environmental factor data records 409. For example, these additional cartographic data records may be analogous to the nodes, links, POIs and/or various records 503-507 but extended into the airspace above the ground.

In one embodiment, the indexes 513 may improve the speed of data retrieval operations in the geographic database 121. In one embodiment, the indexes 513 may be used to quickly locate data without having to search every row in the geographic database 121 every time it is accessed. For example, in one embodiment, the indexes 513 can be a spatial index of the polygon points associated with stored feature polygons.

In exemplary embodiments, the road segment data records 505 are links or segments representing roads, streets, or paths, as can be used in the calculated route or recorded route information for determination of one or more personalized routes. The node data records 503 are end points corresponding to the respective links or segments of the road segment data records 505. The road link data records 505 and the node data records 503 represent a road network, such as used by vehicles, cars, and/or other entities. In addition, the geographic database 121 can contain path segment and node data records or other data that represent 3D paths around 3D map features (e.g., terrain features, buildings, other structures, etc.) that occur above street level, such as when routing or representing flightpaths of aerial vehicles (e.g., drones 101), for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 121 can include data about the POIs and their respective locations in the POI data records 507. The geographic database 121 can also include data about places, such as cities, towns, or other communities, and other geographic features, such as bodies of water, mountain ranges, etc. Such place or feature data can be part of the POI data records 507 or can be associated with POIs or POI data records 507 (such as a data point used for displaying or representing a position of a city).

In one embodiment, the geographic database 121 can also include geo-referenced environmental factor data records 509 for the digital map data representing risk factors or risk-related data, calculated risk levels, risk level visualizations, environmental quality data density predictions generated for regions or interest, and related data. In one embodiment, the risk factor data records 509 can be associated with one or more of the node records 503, road segment records 505, and/or POI data records 507 so that the predicted population densities can inherit characteristics, properties, metadata, etc. of the associated records (e.g., location, address, POI type, etc.). In one embodiment, the system 100 (e.g., via the cargo routing platform 117 can use the environmental quality data density and/or intensity predictions to generate aerial vehicles routes.

In one embodiment, the system 100 can generate navigation routes using the digital map data and/or real-time data stored in the geographic database 121 based on risk level visualization and/or predictions. The resulting aerial routing and guidance can be stored in the aerial routing data records 511. By way of example, the routes stored in the data records 511 can be created for individual 3D flightpaths or routes as they are requested by drones or their operators. In this way, previously generated navigation routes can be reused for future drone travel to the same target location.

In one embodiment, the navigation routes stored in the aerial routing data records 511 can be specific to characteristics of the cargo 102 (e.g., type of item to be delivered, packaging type) and/or other geo-referenced environmental factor characteristics of the route. In addition, the navigation routes generated according to the embodiments described herein can be based on contextual parameters (e.g., time-of-day, day-of-week, season, etc.) that can be used with different environmental quality data density and/or intensity predictions according to the embodiments described herein.

In one embodiment, the geographic database 121 can be maintained by the services platform 111, any of the services 113 of the services platform 111, and/or the cargo routing platform 117). The map developer can collect environmental quality data to generate and enhance the geographic database 121. There can be different ways used by the map developer to collect data. These ways can include obtaining data from other sources, such as municipalities or respective geographic authorities. In addition, the map developer can employ drones (e.g., using the embodiments of the privacy-routing process described herein) or field vehicles (e.g., mapping drones or vehicles equipped with mapping sensor arrays, e.g., LIDAR) to travel along roads and/or within buildings/structures throughout the geographic region to observe features and/or record information about them, for example. Also, remote sensing, such as aerial or satellite photography or other sensor data, can be used.

The geographic database 121 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, environmental data is compiled (such as into a platform specification format (PSF) format) to organize and/or configure the data for performing navigation-related functions and/or services, such as route calculation, route guidance, map display, speed calculation, distance and travel time functions, and other functions, by a navigation capable device or vehicle, such as by the aerial vehicle 101, for example. The navigation-related functions can correspond to 3D flightpath or navigation, 3D route planning for package delivery, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for mapping geo-referenced environmental factors and generating navigation routes may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

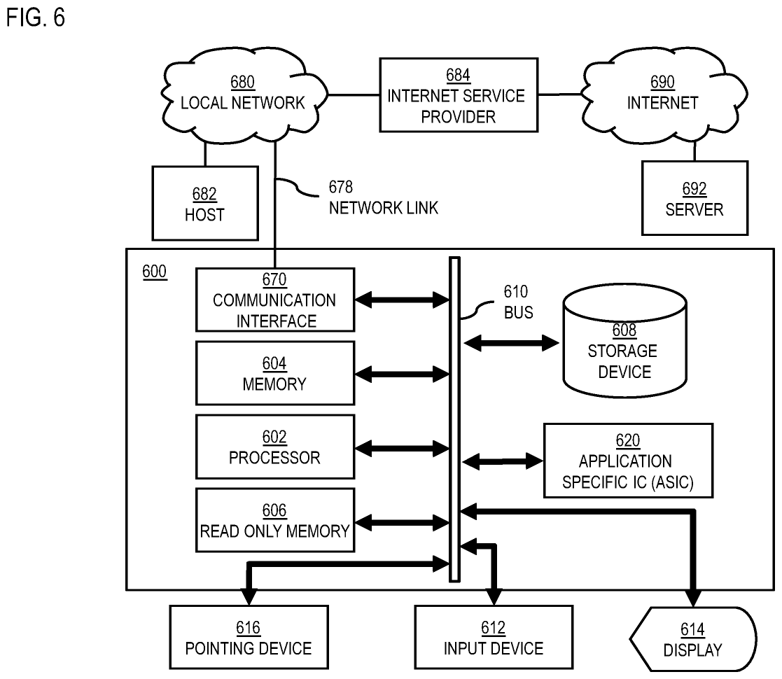

FIG. 6 illustrates a computer system 600 upon which an embodiment of the invention may be implemented. Computer system 600 is programmed (e.g., via computer program code or instructions) to map geo-referenced environmental factors and generate navigation routes as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a range.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to mapping geo-referenced environmental factors and generating navigation routes. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for mapping geo-referenced environmental factors and generating navigation routes. Dynamic memory allows information stored therein to be changed by the computer system 600. RANI allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for mapping geo-referenced environmental factors and generating navigation routes, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general, the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local region network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for mapping geo-referenced environmental factors and generating navigation routes to the UE 101.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system can be deployed in various configurations within other computer systems, e.g., host 682 and server 692.

FIG. 7 illustrates a chip set 700 upon which an embodiment of the invention may be implemented. Chip set 700 is programmed to map geo-referenced environmental factors and generate navigation routes as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to map geo-referenced environmental factors and generate navigation routes. The memory 705 also stores the data associated with or generated by the execution of the inventive steps.

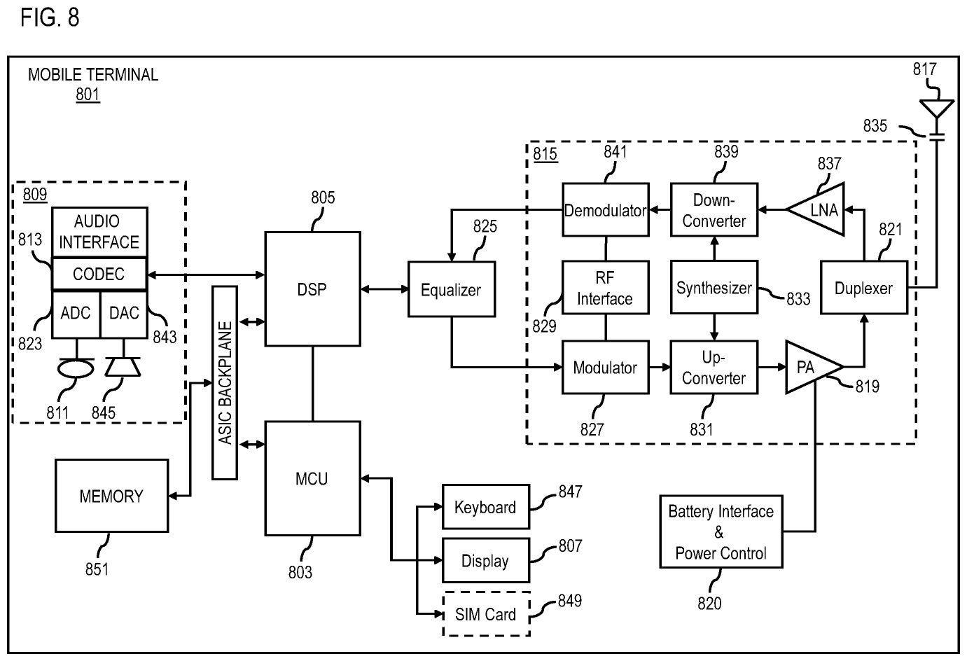

FIG. 8 is a diagram of exemplary components of a mobile terminal 801 (e.g., handset or vehicle/aerial vehicle or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions that offer automatic contact matching. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile station 801 to map geo-referenced environmental factors and generate navigation routes. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and can store other data including music data received via, e.g., the global Internet. The software module could reside in RAM memory, flash memory, registers, or any other form of writable computer-readable storage medium known in the art including non-transitory computer-readable storage medium. For example, the memory device 851 may be, but not limited to, a single memory, CD, DVD, ROM, RAM, EEPROM, optical storage, or any other non-volatile or non-transitory storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

While the invention has been described in connection with several embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method for generating a navigation route based on environmental quality data comprising:
determining a cargo to be carried on the navigation route;
receiving the environmental quality data for a geographic and/or a three-dimensional region associated with at least one candidate route, wherein the environmental quality data indicates whether there is at least one geo-referenced environmental factor that affects the cargo; and
generating the navigation route based on the environmental quality data of the at least one candidate.

2. The method of claim 1, wherein the navigation route is generated for an aerial drone, and wherein the navigation route specifies an altitude to route the aerial drone based on the at least one geo-referenced environmental factor.

3. The method of claim 1, wherein the at least one geo-referenced environmental factor negatively affects the cargo so that the cargo cannot be consumed or used in a manner for which the cargo was made or designed.

4. The method of claim 3, wherein the navigation route is generated to avoid the at least one geo-referenced environmental factor.

5. The method of claim 1, wherein the at least one geo-referenced environmental factor positively affects the cargo so that the cargo is preserved to be consumed or used in a manner for which the cargo was made or designed.

6. The method of claim 5, wherein the navigation route is generated to route through the at least one geo-referenced environmental factor.

7. The method of claim 1, further comprising:
initiating an activation of at least one sensor of a vehicle performing the navigation route,
wherein the at least one sensor is configured to collect sensor data for determining a presence of the at least one geo-referenced environmental factor.

8. The method of claim 7, wherein the sensor data is used to update the environmental quality data, map data associated with the at least one geo-reference environmental quality factor, or a combination thereof.

9. The method of claim 1, further comprising:
calculating a probability of encountering the at least one geo-referenced environmental factor while on the navigation route; and
initiating an evasive maneuver based on determining that the probability is greater than a threshold probability.

10. The method of claim 1, further comprising:
selecting the at least one geo-referenced environmental quality factor based on a cargo type of the cargo.

11. The method of claim 1, wherein the environmental quality data includes real-time data, historical data, or a combination thereof.

12. An apparatus for generating a navigation route based on environmental quality data comprising:
at least one processor; and
at least one memory including computer program code for at least one program,
the at least one memory and the computer program code configured to, with the at least one processor, cause the apparatus to:
receive data indicating at least one geo-referenced environmental factor that is classified as affecting a cargo that is carried on the navigation route;
generate map data representing the at least one geo-referenced environmental factor in a geographic database; and
provide the map data for generating the navigation route.

13. The apparatus of claim 12, wherein the map data is stored in an environmental quality data layer of the geographic database.

14. The apparatus of claim 12, wherein the at least one geo-referenced environmental factor is classified as affecting the cargo based on determining that the at least one geo-referenced environmental factor negatively affects the cargo so that the cargo cannot be consumed or used in a manner for which the cargo was made or designed.

15. The apparatus of claim 12, wherein the at least one geo-referenced environmental factor is classified as affecting the cargo based on determining that the at least one geo-referenced environmental factor positively affects the cargo so that the cargo is preserved to be consumed or used in a manner for which the cargo was made or designed.

16. The apparatus of claim 12, wherein the map data further represents an altitude extent of the at least one geo-referenced environmental factor, and wherein the navigation route specifies an altitude to route an aerial drone based on the altitude extent, the at least one geo-referenced environmental factor, or a combination thereof.

17. A non-transitory computer-readable storage medium carrying one or more sequences of one or more instructions which, when executed by one or more processors, cause an apparatus to perform:
determining a cargo to be carried on a navigation route;
receiving environmental quality data for a geographic and/or a three-dimensional region associated with at least one candidate route;
determining that the environmental quality data indicates that there is at least one geo-referenced environmental factor that is classified as affecting the cargo; and
generating a map data layer based on the environmental quality data including the at least one geo-referenced environmental factor,
wherein the map data layer is stored in a geographic database.

18. The non-transitory computer-readable storage medium of claim 17, wherein the apparatus is caused to further perform:
retrieving real-time data, historical data, or a combination thereof indicating the environmental quality data,
wherein the environmental quality data is based on the real-time data, the historical data, or a combination thereof.

19. The non-transitory computer-readable storage medium of claim 17, wherein the apparatus is caused to further perform:
creating a data model representing the at least one geo-referenced environmental factor, wherein the map data layer further includes the data model.

20. The non-transitory computer-readable storage medium of claim 19, wherein the apparatus is caused to further perform:
generating a navigation route based on the data model representing the at least one geo-referenced environmental factor in combination with terrain data.
